(19) United States
(12) Patent Application Publication
(10) Pub. No.: US 2007/0223485 A1
(43) Pub. Date: Sep. 27, 2007

(54) Method for Providing Functionality of an Exchange Termination Unit and a Line Termination Unit in a Communication Network

(75) Inventor: Wieland Roesser, Behrendorff (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/594,347

(22) PCT Filed: Feb. 26, 2005
(86) PCT No.: PCT/EP05/02058

§ 371 Date: Sep. 26, 2006

(30) Foreign Application Priority Data
Mar. 27, 2005 (DE) 10 2004 015 157.1

(51) Int. Cl. H04Q 11/04

(52) U.S. Cl. 370/395.1; 370/389

(57) ABSTRACT

A method for providing the functionality of an exchange termination unit (ET) and a line termination unit (LT) in a communication network (NW) that on the subscriber side has at least one time-multiplex-oriented partial network (ISDN) and on the transport side at least one packet-oriented partial network (NGN), with a gateway (AGW) and a media gateway controller (GWC) being arranged at the transport-side end of the time-multiplex-oriented partial network (ISDN), with the functionality of the exchange termination unit (ET) and of the line termination unit (LT) being implemented in the gateway (AGW) and/or in the media gateway controller (GWC).

The invention relates to a method for providing the functionality of an exchange termination unit and a line termination unit in a communication network. Furthermore, the invention relates to a communication network for the exchange of information that transmits the information on the subscriber side via at least one time-multiplex-oriented partial network and on the transport side via at least one packet-oriented partial network.

The information includes, for example, user data or voice data. The time-multiplex-oriented communication network is, for example, an ISDN (Integrated Service Digital Network) data transmission network. In the time-multiplex-oriented communication network the data is transmitted in various time slots according to a time-multiplex procedure. A packet-oriented communication network is a network in which the information or data is transmitted in data packets. The packet-oriented communication network is, for example, a communication network that operates according to the Internet protocol. A further example of a packet-oriented communication network is an ATM (Asynchronous Transfer Mode) network, but in this case the data packets are called cells.

Functions for operation, administration or maintenance in the time-multiplex-oriented communication network have, for example, been specified in the following standards of the ETSI (European Telecommunications Standards Institute) or of the ITU-T (International Telecommunications Union—Telecommunication Standardization Sector):
ETSI ETS 300 233, Integrated Services Digital Network (ISDN); Access Digital Section for ISDN Primary Rate, May 1994,
ITU-T G.962, Digital Sections and Digital Line Systems; Access Digital Section for ISDN Primary Rate at 2048 Kbit/s, 03/93,
ETSI ETS 300 011, Integrated Services Digital Network (ISDN); Primary Rate User-Network Interface Layer 1 Specification and Test Principles, April 1992.

Thus, the functions for operation, administration or maintenance refer for example to the switching of test loops or error control. These functionalities are generally summarized under the term OAM mechanisms. OAM stands for Organization Administration and Management of the communication network using a Telecommunications Management Network (TMN) that, for example, has an Operations System (OS) according to CCITT Recommendation M.30 that accesses the Q3 interface.

In the time-multiplex-oriented network, these functions are monitored for the ISDN primary rate access digital section (DS), i.e. for the digital message transmission path between a reference point T and a primary rate access V3 established as a reference point (T lies between the subscriber terminal and the network termination unit on the subscriber side (NT: Network Termination Unit) and V3 lies between the physical line termination unit (LT; Line Termination Unit) on the transport side and the logic exchange termination unit (ET: Exchange Termination Unit), monitored by the exchange termination unit in conjunction with the network termination unit on the subscriber side and the line termination unit on the transport side (see also CCITT Recommendation Q.542 and

“Peter Bocker: ISDN—Das diensteintegrierende digitale Nachrichtennetz [The service-integrating digital message network], third edition, 1990, Springer-Verlag, Heidelberg, pages 149-151” with references to CCITT Recommendations Q.511 and Q.512).

However, in the interaction between time-multiplex-oriented communication networks and packet-oriented communication networks, new problems arise because such OAM tasks (organization, administration and management) have to be distributed between both types of communication network according to the arrangement of the interface.

For a case where the digital ISDN access section DS is replaced by an ATM network and the advantages of the AAL2 (ATM Forum) are used, a simple method is known from European Patent Application EP1 374 629 A1 for the transmission of information within at least one time-multiplex-oriented communication network via at least one packet-oriented communication network, with functions for operation, administration and maintenance of the time-multiplex-oriented communication network continuing to be useable in the time-multiplex-oriented communication network in that these functions are emulated in the packet-oriented network. With this method, at least part of the information is transmitted via the packet-oriented communication network. In doing so, at least part of the functions for operation, administration and maintenance are emulated, i.e. simulated, by the packet-oriented communication network. Essentially unrestricted, continued use of the functions specified for the time-multiplex-oriented communication network is possible in this way.

In contrast, in VoIP networks or generally in the so-called new generation networks (NGN with convergence of voice and data) so-called ISDN-PRI interfaces (interfaces with an ISDN Primary Rate Interface) are required, for which the OAM mechanisms from the time-multiplex-oriented technology also have to be provided in a packet-oriented technology of that kind. In this way, the OAM mechanisms, as described in the relevant standards (G.962, ETS 300 233, ITU-T I.411, I.412, Q.152), could be adopted, which would have an advantageous effect on the reusability of equipment already in use and the reusability of known OAM sequences.

The object of the invention is therefore to specify a method and a communication network by means of which a “Primary Rate Access. Digital Section” (DS), such as the ISDN-PRIs, is monitored in an NGN environment with the existing OAM mechanisms being retained.

This object is achieved with respect to the method in accordance with the invention by a method for providing the functionality of an exchange termination unit and a line termination unit in a communication network that on the subscriber side has at least one time-multiplex-oriented partial network and at least one packet-oriented partial network on the transport side, with a gateway and a media gateway controller or an SIP server being arranged at the transport-side end of the time-multiplex-oriented partial network, with the functionality of the exchange termination unit and of the line termination unit being implemented in the gateway and/or in the media gateway controller or in the SIP server.

With respect to the communication network, the object in accordance with the invention mentioned above is achieved in that a communication network for the exchange of information is provided, that transmits the information on the subscriber side via at least one time-multiplex-oriented partial network and on the transport side via at least one packet-oriented partial network, with a gateway and a media gateway controller or an SIP server being arranged at the transport-side end of the time-multiplex-oriented partial network, with the functionality of an exchange termination unit and of a line termination unit being implemented in the gateway and/or the media gateway controller or in the SIP server.

In this way, the functionality of the logic exchange termination unit and of the physical line termination unit is implemented in the gateway and/or the media gateway controller or the SIP server, by which means, despite the presence of the packet-oriented network with respect to the OAM mechanisms, no changes whatsoever result with respect to the OAM mechanisms run in the previous time-multiplex-oriented networks.

Thus the gateway and/or media gateway controller or the SIP server is fitted with the corresponding time-multiplex-oriented functional logic units (OAM functions and corresponding status machine), so that in the implemented exchange termination unit and the implemented line termination unit functions for the operation and/or administration and/or maintenance are realized in the time-multiplex-oriented partial network for the transmission of information within the complete, i.e. time-multiplex-oriented partial network and packet-oriented partial network.

In an advantageous embodiment of the invention, the functionality of the exchange termination unit can be implemented in the media gateway controller (called a soft switch) and the functionality of the line termination unit can be implemented in the gateway, so that the exchange of signals between the gateway and media gateway controller is performed according to the gateway controller protocol. Corresponding expansions for H.248 (MEGACO), MGCP are possible by defining new packages. For SIP (Session Initiated Protocol) controlled gateways, an implementation by expanding the SIP standard by applying a new standardization proposal is also possible (RFC: Request for Comments). For SIP, this means that either the functionalities of the line termination and of the exchange termination can be arranged in the gateway or the functionality of the line termination can be arranged in the gateway and the functionality of the exchange termination in the SIP server.

In a development of this invention, the packet-oriented communication network can be realized according to the Internet protocol, according to ATM or according to the SIP specification.

For the time-multiplex-oriented communication network, an ISDN network can be used that, as before, is very significant with regard to its propagation. Correspondingly, the functions for operation, administration and maintenance can essentially be performed according to standard ETSI ETS 300 011 and/or according to standard ITU-T G.962 and/or according to standard ETSI ETS 300 233, so that a comparatively simple and fast implementation is possible because mechanisms that are already known and have already been introduced are used for the implementation.

Further advantageous embodiments of the invention are given in the remaining subclaims.

Exemplary embodiments of the invention are explained in the following with the aid of the accompanying drawings. These are as follows:

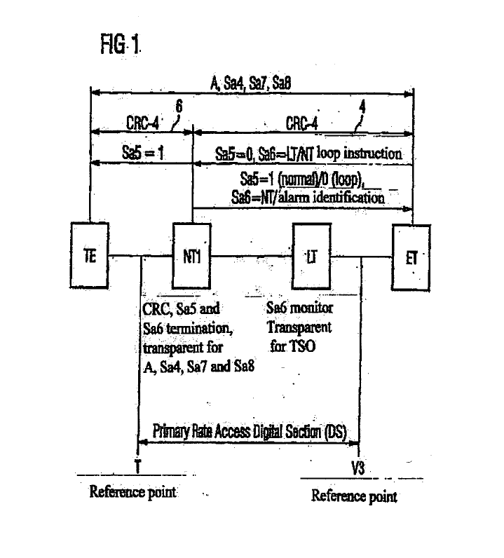

FIG. 1. An ISDN primary multiplex interface model showing the processing of a time slot TSO in compliance with standard ETSI ETS 300 233 according to prior art,

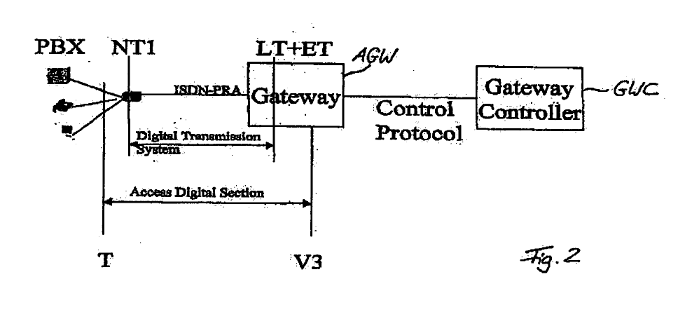

FIG. 2. A schematic illustration of a first packet-oriented communication network with ISDN primary rate access connections,

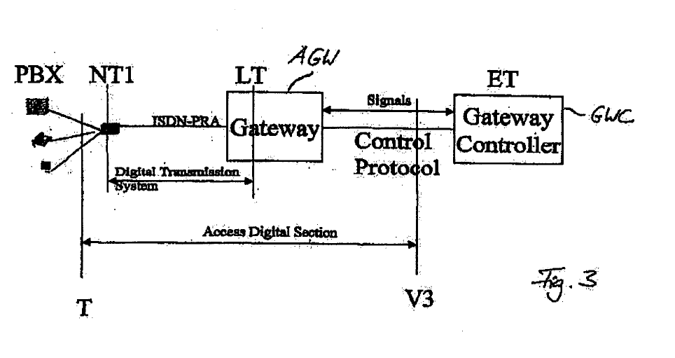

FIG. 3. A schematic representation of a second packet-oriented communication network with ISDN primary rate access connections, and

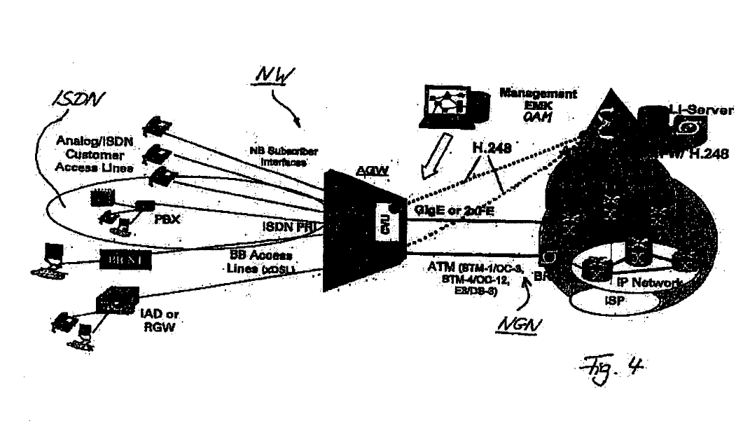

FIG. 4. A schematic representation of a communication network with a pronounced ATM burden.

An overview showing the application of the ISDN primary multiplex interface in the world of conventional time multiplex (TDM—Time Division Multiplex) is first given in the following. Furthermore, requirements are specified that must be fulfilled if parts of the access digital section (DS—access digital section) of the primary digital access are replaced by an ATM network. Furthermore, methods are specified that fulfill these requirements.

ISDN primary multiplex interface model (PRI) with operating and maintenance functions (for a 2048 kbps signal/E1)

FIG. 1 shows an access digital section DS with its boundaries and the processing of the time slot TSO.

The operating and maintenance functions support methods and information elements necessary for the control of the access digital section through a logic exchange termination unit ET or a service node.

An Sa5 bit, an Sa6 bit, an E bit and an A bit of a time slot TSO are relevant for display and control. The bit structure of the time slot TSO and the multi-timeframe structure are specified according to standard ITU-T G.704. The A bit is used for alarm status information between the service network node and customer telephony end -equipment TE. Only the A bit has to be monitored and is transmitted transparently. All other control bits of the time slot TSO are to be transmitted transparently. Furthermore, the elements of the access digital section DS that use CRC methods 4, 6 (cyclic redundancy check) are shown in FIG. 1. The CRC-4 methods 4, 6 are implemented and used between the exchange termination unit ET and a network termination unit NT1, and also between the network termination unit NT1 and the customer telephony end equipment TE. In standard ITU-T G.962 this is also known as option 2.

Furthermore, FIG. 1 shows a line termination unit LT. A V3 reference point (called the primary rate access) is positioned between the line termination unit LT and exchange termination unit ET. A T-reference point lies between the customer telephony end equipment TE and the network termination unit NT1.

The following table shows the signals that are exchanged between the T-reference point and the access digital section DS under the standard operating conditions and instances of error stipulated in standard ETS 300 011.

| Name | List of signals |
|---|---|
| Normal operating mode | Operating timeframes with: |
| timeframes | active assigned CRC bits, |
| | CRC error information (see |
| | standard ITU-T G.704 for 2048 Kbit/s |
| | systems), |
| | no error indications |
| RAI (Remote Alarm | Operating timeframes with: |
| Indication) | active assigned CRC bits |
| | CRC error information (see |
| | standard ITU-T G.704 for 2048 Kbit/s |
| | systems) |
| | Remote alarm indication (see |
| | standard ITU-T G.704, table 4a, |
| | for 2048 Kbit/s systems, A bit |
| | is set to the value 1). |
| LOS (Loss of Signal) | No input signal received (LOS) |
| AIS (Alarm Indication | Continuous flow of bits with the |
| Signal) | value 1 |
| CRC error information | E bit according to standard ITU-T |
| | G.704, table 4b set to the value 0 |
| | if a faulty CRC block is received |
| | (only for a 2048 Kbit/s system). |

The signals exchanged between the access digital section DS and the exchange termination unit ET are specified in the following table:

| Name | List of signals |
|---|---|
| Normal operating mode | Operating timeframes with: |
| timeframes | Active assigned CRC bits |
| | CRC error information (see |
| | standard ITU-T G.704 for 2048 Kbit/s |
| | systems) |
| | No error indications |
| RAI (Remote Alarm | Operating timeframe with: |
| Indication) | active CRC bits |
| | CRC error information (see |
| | standard ITU-T G.704 for 2048 Kbit/s |
| | systems) |
| | Remote alarm indication (see |
| | standard ITU-T G.704, table 4a, |
| | for 2048 Kbit/s systems, A bit |
| | is set to the value 1) |
| LOS (Loss of Signal) | No input signal received (LOS) |
| AIS (Alarm Indication | Continuous flow of bits with the |
| Signal) | value 1. |
| CRC error information | E bit according to standard ITU-T |
| | G.704, table 4b set to the value 0 |
| | if a faulty CRC block is received |
| | (only for a 2048 Kbit/s system) |

The following additional signals are necessary to indicate fault conditions that occur with respect to the access digital section DS:

| Name | List of signals |
|---|---|
| Standard timeframes | These are timeframes without error |
| | indications or test loop |
| | requirements generated by the |
| | exchange termination unit ET or the |
| | customer telephony end equipment |
| | TE, with an A bit with the value 1 |
| | or 0 not being relevant for the |
| | access digital section DS. |
| Timeframes | These are timeframes that in |
| | addition to the normal timeframes |
| | contain error indication signals in |
| | the Sa6 bits that have been |
| | generated in the network |
| | termination unit NT1 and |
| | transmitted to the exchange |
| | termination unit ET. Alternatively, |
| | the Sa6 bits can contain test loop |
| | requirements that have been |
| | transmitted from the exchange |
| | termination unit ET to the access |
| | digital section DS. |
| | In this case, the Sa5 bit is also |
| | used to indicate the direction and |
| | for test loop indication. The Sa5 |
| | bit in the transmission direction |
| | from the access digital section DS |
| | to the exchange termination unit ET |
| | is set in the network termination |
| | unit NT1 or in the line termination |
| | unit LT and transmitted to the |
| | exchange termination unit ET |
| | according to the following rules: |
| | Sa5 = 1 test loop 2 not |
| | activated |
| | SA5 = 0 test loop 2 activated |
| | The SA6 bits are numbered as |
| | Sa6(1), Sa6(2), Sa6(3), Sa6(4) and |
| | synchronized with the sub-multi- |
| | timeframes, further explained below |
| | using FIG. 3. |
| Alternate timeframes | In the event of a signal loss (LOS) |
| | or loss of the frame alignment |
| | (LFA) at the T-reference point of |
| | the network termination unit NT1, a |
| | new timeframe must be generated. |
| | The A bit is set to the value 0 and |
| | the Sa4, Sa5, Sa7 and Sa8 bits as |
| | well as the bits of time slots TS1 |
| | to TS31 are set to the value 1. A |
| | bit sequence of Sa6 bits is used to |
| | indicate this fault case. |
| LFA (Loss of Frame | Loss of frame alignment |
| Alignment) | |
| Failure of operating | |
| voltage in the network | |
| termination unit NT1 or | |
| line termination unit | |
| LT | |
| Auxiliary bit pattern | This is a continuous sequence of |
| (AUXP - Auxiliary | bits without a timeframe with the |
| Pattern) | alternating values 1 and 0 ( . . . |
| | 101010 . . . ) that is transmitted from |
| | the line termination unit LT in |
| | both transmission directions if a |
| | signal loss (LOS) is detected at |
| | the corresponding reception unit. |

CRC 4 Method

The CRC method is used to protect against faulty frames (framing) and for error performance monitoring. This includes the multi-timeframe method as specified in standard ITU-T G.704.

Operation and Maintenance of the Access Digital Section

The access digital section DS supplies the means for transmitting indication elements and for detecting error cases at the T-reference point interface and at the V3-reference point interface as well as for supporting test procedures. According to standard ETSI ETS 300 233, the following functions are supported in conjunction with network termination NT1 and line termination LT through the exchange termination unit ET:
Test loops
   Test loop 1, (loopback), transparent test loop in the line termination unit LT or the network transmission unit CO-IWF on the exchange termination unit side,
   Test loop 2, transparent test loop in the network termination unit NT1 or in the network transmission unit CP-IWF on the customer side
Fault cases
   Within the access digital section DS
      Loss of signal (LOS) or loss of the frame alignment (LFA) on the line side of the network termination unit NT1 or network transmission function CP-IWF on the customer side (in the signal coming from the line termination unit LT or network transmission unit CO-IWF on the exchange termination unit side to the network termination unit NT1 or network transmission unit CP-IWF on the customer side, also called the downstream signal),
   Signal loss (LOS) on the line side of the line termination unit LT or network transmission unit CO-IWF on the exchange termination unit side,
   Failure of operating voltage in the network termination unit NT1 or network transmission unit CP-IWF on the customer side,
   AIS (Alarm Indication Signal) on the line side of the network termination unit NT1 or network transmission unit CP-IWF on the customer side, with the AIS being generated in the network and forwarded transparently through the line termination unit LT or network transmission unit CO-IWF on the exchange termination unit side.
At the V3-reference point
   Signal loss (LOS)
At the T-reference point
   Signal loss (LOS) or loss of frame alignment (LFA),
   Failure of operating voltage (if relevant)
Error performance monitoring
   Faulty CRC blocks detected on the line side of the network termination unit NT1 or network transmission unit CP-IWF on the customer side,
   Faulty CRC blocks detected at the T-reference point of the network termination unit NT1 or network transmission unit CP-IWF on the customer side,
   CRC error indication received from the customer telephony end equipment TE in the E bit.
   Faulty CRC blocks detected at the T-reference point of the network termination unit NT1 or network transmission unit CP-IWF on the customer side and simultaneous reception of CRC error information from the customer telephony end equipment TE.

These complete OAM mechanisms are initially not available when the transmission on the transport side (exchange termination unit side) is replaced by a packet-oriented communication network, e. g. H.248 or Ethernet GigE or 2xFE or ATM. They are, however, again available in a first arrangement according to FIG. 2, whereby the line termination LT and exchange termination ET are implemented in an access gateway AGW. In this way, the functions of the line termination LT and exchange termination ET are emulated in the access gateway AGW. In particular these are exactly the test loops, error cases and error performance monitoring specified in the proceeding section. The functional elements of the AN (Access Digital Link) can thus be monitored, for example to also provide transmission performance information according to G.821. Furthermore, the maintenance communication devices can be linked in via relevant interfaces such as the Q3 interface or an interface (TCP/IP) supporting an SNMP (Simple Network Management Protocol) as a telecommunications management network (TMN), in order to control the test and monitoring mechanisms, to evaluate data from the loops, performance and error messages and to initiate appropriate measures. The implementation of the status machine of the exchange termination ET according to table A.1/G.962 is necessary for this purpose.

A second arrangement according to the invention, schematically illustrated in FIG. 3, differs from the first arrangement in that the functionality of the exchange termination ET is implemented in the media gateway controller GWC. In this way, the media gateway controller GWC provided with the functionality of the exchange termination ET, can monitor all the access gateways AGW controlled by it with the full OAM functionality of the time-multiplex-oriented network used, that is thus also required for the time-multiplex-oriented partial network to achieve the above advantages. The SLDM (subscriber line management digital) is thus moved to the media gateway controller GWC. In the case of the SIP network, the media gateway controller GWC would in this case be replaced by an SIP server and a functionality of the exchange termination would be implemented accordingly in the SIP server.

FIG. 4 shows a schematic overview of a possible embodiment for a communication network NW that includes a time-multiplex-oriented partial network ISDN that is linked via ISDN access interfaces ISDN-PRI (Primary Rate Interface) to a gateway AGW for a packet-oriented partial network NGN. The packet-oriented partial network moreover includes transmission methods according to ITU-T standard H.248 (Media Gateway Control Protocol), Ethernet (GigE or 2xFE) and ATM (STM-1/OC-3:155 Mbps; STM-4/OC-12622 Mbps, E3/D3-3: European Signal Level 3/Digital Signal Level 3). In addition to the ISDN access interfaces ISDN-PRI, the actual regulation access interfaces for broadband access (BB access) and the packet-oriented through signaling of information to a packet-oriented subscriber-side network terminal IAD (IAD: Integrated Access Device) is provided at the gateway AGW. Furthermore, a management system EMK is provided that executes the conventional OAM mechanisms usual for the time-multiplex-oriented partial network ISDN on the basis of the previously described implementation of the LT and ET functionality.

1. A method for providing of an operating and maintenance function in a communication network (NW) that comprises on the subscriber side an ISDN-network and on the transport side at least one packet-oriented network (NGN), with a gateway (AGW) and a media gateway controller (GWC) being arranged at the transport-side end of the ISDN network with the functionality of the exchange termination unit (ET) and of the line termination unit (LT) being implemented in the gateway (AGW) and/or in the media gateway controller (GWC).

2. (canceled)

3. The method according to claim 1, wherein
functions (OAM) for at least one of operation, administration and maintenance in the time-multiplex-oriented communication network (ISDN) are realized in the exchange termination unit (ET) and line termination unit (LT) for transmission of information within the time-multiplex-oriented communication network (ISDN).

4. The method according to claim 1, wherein
the functionality of the exchange termination unit (ET) is implemented in the media gateway controller (GWC) and the functionality of the line termination unit (LT) is implemented in the access gateway (AGW).

5. The method according to claim 1, wherein
the packet-oriented communication network (NGN) is realized according to at least one of the Internet protocol (IP), SIP and ATM.

6. The method according to claim 1, wherein
the time-multiplex-oriented partial network (ISDN) is one of an ISDN network and a number of ISDN-SSist.

7. The method according to claim 3, wherein
the functions (OAM) for operation, administration and maintenance are essentially performed according to at least one of standard ETSI ETS 300 011, standard ITU-T G.962 and standard ETSI ETS 300 233.

8. A communication network (NW) for exchange of information that transmits the information on a subscriber side via at least one time-multiplex-oriented partial network (ISDN) and on a transport side via at least one packet-oriented partial network (NGN), with a gateway (AGW) and a media gateway controller (GWC) being arranged at the transport-side end of the time-multiplex-oriented partial network (ISDN), with the functionality of an exchange termination unit (ET) and of a line termination unit (LT) being implemented in at least one of the gateway (AGW) and the media gateway controller (GWC).

9. (canceled)

10. A method for providing a functionality of an exchange termination unit (ET) and a line termination unit (LT) in a communication network (NW) that on a subscriber side has at least one time-multiplex-oriented partial network (ISDN) and on a transport side at least one packet-oriented partial network (NGN), with a gateway (AGW) and an SIP server being arranged at the transport-side end of the time-multiplex-oriented partial network (ISDN), with the functionality of the exchange termination unit (ET) and of the line termination unit (LT) being implemented in at least one of the gateway (AGW) and the SIP server.

11. The method according to claim 10, wherein functions (OAM) for at least one of operation, administration and maintenance in the time-multiplex-oriented communication network (ISDN) are realized in the exchange termination unit (ET) and line termination unit (LT) for the transmission of information within the time-multiplex-oriented communication network (ISDN).

12. The method according to claim 10, wherein the packet-oriented communication network (NGN) is realized according to at least one of the Internet protocol (IP), SIP and ATM.

13. The method according to claim 10, wherein the time-multiplex-oriented partial network (ISDN) is one of an ISDN network and a number of ISDN-SSist.

14. The method according to claim 11, wherein the functions (OAM) for operation, administration and maintenance are essentially performed according to at least one of standard ETSI ETS 300 011, standard ITU-T G.962 and standard ETSI ETS 300 233.
